(19) United States
(12) Patent Application Publication
(10) Pub. No.: US 2019/0383952 A1
(43) Pub. Date: Dec. 19, 2019

(54) WATER DOSIMETRY DEVICE USING X-RAY INDUCED ULTRASONIC WAVES

(71) Applicants: POSTECH ACADEMY-INDUSTRY FOUNDATION, Pohang-si (KR); KOREA RESEARCH INSTITUTE OF STANDARDS AND SCIENCE, Daejeon (KR)

(72) Inventors: Chul Hong KIM, Pohang-si (KR); In Jung KIM, Daejeon (KR); Byoung Chul KIM, Daejeon (KR); Eun Yeong PARK, Pohang-si (KR); Chul Yong YI, Daejeon (KR); Jeesu KIM, Pohang-si (KR); Yuhan JUNG, Pohang-si (KR); Joong Hyun KIM, Daejeon (KR)

(21) Appl. No.: 16/488,236

(22) PCT Filed: Feb. 2, 2018
(86) PCT No.: PCT/KR2018/001471

§ 371 Date: Aug. 22, 2019

(30) Foreign Application Priority Data
Feb. 24, 2017 (KR) 10-2017-0025105

(51) Int. Cl. G01T 1/204; G01T 1/161

(52) U.S. Cl. CPC G01T 1/204; G01T 1/02; G01T 1/1612

(57) ABSTRACT

The present invention relates to a water dosimetry device using X-ray induced ultrasonic waves, in which a medical X-ray linear accelerator and an ultrasonic transducer are combined to construct a medical X-ray linear accelerator-based ultrasound imaging device, so that a radiation-absorbed dose in water when X-rays irradiate the water is measured in real time.

### TECHNICAL FIELD

The present invention relates to a water dosimetry device using X-ray induced ultrasonic waves. More particularly, the present invention relates to a water dosimetry device using X-ray induced ultrasonic waves, in which an X-ray induced ultrasonic signal is acquired using water, which has a similar environment to an interior of a human body, and an absorbed dose in the water when X-rays irradiate the water is measured by analyzing an absorbed dose of X-rays.

### BACKGROUND ART

Generally, compared with the conventional operation methods, radiotherapy is preferred in spite of high costs because a physical and mental burden on a patient is low, there are few side effects such as complications, or the like, and daily life is generally uninterrupted. That is, a radiotherapy device treats diseases by intensively irradiating an affected part of a human body with radiation. When performing radiation, a radiation dose to be absorbed into the affected part is prescribed comprehensively considering patient's condition, a size and a characteristic of the affected part, or the like. To this end, under establishment of a radiotherapy program, a radiation dose appropriate for the treatment is radiated. Since radiation itself has a bad influence on a human body, radiation is radiated so that only the dose required to treat the affected part of the patient is absorbed, thereby preventing the human body from excessively absorbing the radiation and from excessively being exposed to radiation.

However, in the case of the conventional general radiotherapy devices, hospitals determine output of radiation suitable for the patient on the basis of data of device information provided by the device manufacturers. Even though the accuracy of the radiotherapy device is high at the initial stage after installation, the accuracy of the radiotherapy device is degraded over time and the amount of the output may vary. Thus, there is a problem that excessive exposure to radiation may occur during radiotherapy. Since X-rays were found and used for treatment, there have been many efforts to find out whether or not X-rays properly irradiate a target part during X-ray treatment. However, a technique for measuring distribution of a dose in real time has not been commercialized yet.

### DISCLOSURE

### Technical Problem

Accordingly, the present invention has been made keeping in mind the above problems with the conventionally-proposed methods in the related art, and the present invention is intended to propose a water dosimetry device using X-ray induced ultrasonic waves, in which a medical X-ray linear accelerator and an ultrasonic transducer are combined to construct a medical X-ray linear accelerator-based ultrasound imaging device, so that a radiation-absorbed dose in water when X-rays irradiate the water is measured in real time.

Also, the present invention is intended to propose a water dosimetry device using X-ray induced ultrasonic waves, in which a radiation dose distribution in a wide area is acquired in real time through 3D scanning by an ultrasonic transducer in a form of a linear, arc, or circular array, and a treatment state during clinic radiotherapy is monitored in real time, thereby minimizing radiation exposure during radiotherapy of a patient, and increasing treatment effect.

Also, the present invention is intended to propose a water dosimetry device using X-ray induced ultrasonic waves, in which an X-ray dose in water, which has a similar environment to an interior of a body, is measured in real time and the distribution thereof is acquired, so that probability of real-time dose measurement in a body is provided. Further, the present invention is utilized as a technology for developing a new-concept radiation dose measurement device that is capable of real-time monitoring a treatment state in radiotherapy using protons, neutrons, or the like, as well as in X-ray treatment.

### Technical Solution

In order to achieve the above object, according to one aspect of the present invention, there is provided a water dosimetry device using X-ray induced ultrasonic waves, the water dosimetry device including:
a water phantom unit filed with water, in which a target of a probe sample is placed therein;
a medical X-ray linear accelerator generating pulse X-rays and irradiating the target in the water phantom unit;
an ultrasonic transducer detecting an X-ray induced ultrasonic signal generated when thermal expansion occurs momentarily as the pulse X-rays radiated from the medical X-ray linear accelerator irradiate the water and then are absorbed;
an amplifying unit amplifying the X-ray induced ultrasonic signal detected by the ultrasonic transducer and outputting the amplified X-ray induced ultrasonic signal;
a data acquisition unit (DAQ) converting the amplified X-ray induced ultrasonic signal output from the amplifying unit into a digital signal and outputting the digital signal; and
a data processing unit (PC) analyzing digitized data output from the data acquisition unit and measuring a radiation-absorbed dose.

Preferably, the X-ray induced ultrasonic signal is a sound pressure generated when thermal expansion occurs momentarily as the pulse X-rays irradiate the water and then are absorbed, and the sound pressure radiates from a source in all directions and contains information on an X-ray absorbed dose.

More preferably, doses of the X-rays vary depending on a depth of the irradiated water, a size of the X-ray induced ultrasonic signal is proportional to a size of an absorbed radiation dose, and the X-ray induced ultrasonic waves have little attenuation in water, so that the absorbed radiation dose is measured.

Preferably, the water phantom unit is provided in a form of a water tank filled with the water and with a top opened.

Preferably, the water phantom unit further includes a 3-axis motor stage moving the ultrasonic transducer on three axes.

More preferably, the ultrasonic transducer is coupled with the 3-axis motor stage, performs 3D scanning using three-axis movement on X-Y-Z axes, and detects and acquires the X-ray induced ultrasonic signal as a result of the 3D scanning.

More preferably, the ultrasonic transducer is implemented as a focus-type single-element ultrasonic transducer.

More preferably, the ultrasonic transducer is implemented as one among a linear array transducer, an arc array transducer, and a circular array transducer.

More preferably, the data processing unit measures the radiation-absorbed dose in real time using the X-ray induced ultrasonic signal detected by the ultrasonic transducer in real time, and on the basis of 3D scanning by the ultrasonic transducer, a cross-section radiation-absorbed dose per angle with respect to a position of the target of the prove sample is measured.

More preferably, the data processing unit collects a measurement value of the cross-section radiation-absorbed dose per angle to acquire a radiation dose distribution in a form of a 3D image, and outputs the distribution for display so as to be monitored.

In order to achieve the above object, according to another aspect of the present invention, there is provided a water dosimetry device using X-ray induced ultrasonic waves, the water dosimetry device including:
a water device composition unit in which a water tube filled with water is provided with an animal placed therein, and a rotary stage rotating the water tube is provided under the water tube;
a medical X-ray linear accelerator generating pulse X-rays and irradiating the animal placed in the water tube;
an ultrasonic transducer detecting an X-ray induced ultrasonic signal generated when thermal expansion occurs momentarily as the pulse X-rays radiated from the medical X-ray linear accelerator irradiate the water and then are absorbed;
an amplifying unit amplifying the X-ray induced ultrasonic signal detected by the ultrasonic transducer and outputting the amplified X-ray induced ultrasonic signal;
a data acquisition unit (DAQ) converting the amplified X-ray induced ultrasonic signal output from the amplifying unit into a digital signal and outputting the digital signal; and
a data processing unit (PC) analyzing digitized data output from the data acquisition unit and measuring a radiation-absorbed dose.

Preferably, the X-ray induced ultrasonic signal is a sound pressure generated when thermal expansion occurs momentarily as the pulse X-rays irradiate the water and then are absorbed, and the sound pressure radiates from a source in all directions and contains information on an X-ray absorbed dose.

More preferably, doses of the X-rays vary depending on a depth of the irradiated water, and a size of the X-ray induced ultrasonic signal is proportional to a size of the absorbed radiation dose.

Preferably, the ultrasonic transducer is placed inside the water tube that the rotary stage rotates.

More preferably, the ultrasonic transducer is implemented as an arc array transducer, performs circular scanning on the water tube that the rotary stage rotates, and detects and acquires the X-ray induced ultrasonic signal as a result of the circular scanning.

More preferably, the data processing unit is configured to, measure the radiation-absorbed dose in real time using the X-ray induced ultrasonic signal detected by the ultrasonic transducer; measure, on the basis of the circular scanning by the ultrasonic transducer, a cross-section radiation-absorbed dose per circular angle with respect to a position of the animal; and collect a measurement value of the cross-section radiation-absorbed dose per circular angle to acquire a radiation dose distribution in a form of a 3D image and output the distribution for display so as to perform monitoring.

In order to achieve the above object, according to still another aspect of the present invention, there is provided a water dosimetry device using X-ray induced ultrasonic waves, the water dosimetry device including:
a gel pad filled with water and placed on an affected part of a treatment target patient lying on a bed;
a medical X-ray linear accelerator generating pulse X-rays and irradiating the affected part of the treatment target patient on which the gel pad filled with the water is placed;
an ultrasonic transducer detecting an X-ray induced ultrasonic signal generated as the pulse X-rays radiated from the medical X-ray linear accelerator pass through the gel pad, which serves as a medium, and the affected part absorbs the X-rays;
an amplifying unit amplifying the X-ray induced ultrasonic signal detected by the ultrasonic transducer and outputting the amplified X-ray induced ultrasonic signal;
a data acquisition unit (DAQ) converting the amplified X-ray induced ultrasonic signal output from the amplifying unit into a digital signal and outputting the digital signal; and
a data processing unit (PC) analyzing digitized data output from the data acquisition unit and measuring a radiation-absorbed dose.

Preferably, the ultrasonic transducer is implemented as an arc array transducer moving in a longitudinal direction of the bed to scan the treatment target patient lying on the bed.

More preferably, the ultrasonic transducer is used by being replaced with a circular or linear array transducer in addition to the arc array transducer.

More preferably, the data processing unit is configured to, measure the radiation-absorbed dose in real time using the X-ray induced ultrasonic signal detected by the ultrasonic transducer in real time; and measure and monitor, on the basis of the scanning by the ultrasonic transducer in the longitudinal direction of the bed, the radiation-absorbed dose on the affected part by using, as a medium, the gel pad placed on the affected part of the treatment target patient lying on the bed, whereby radiotherapy is performed and simultaneously, a damage caused by wrong radiation exposure is minimized on the basis of the monitoring.

### Advantageous Effects

According to the water dosimetry device using X-ray induced ultrasonic waves proposed in the present invention, a medical X-ray linear accelerator and an ultrasonic transducer are combined to construct a medical X-ray linear accelerator-based ultrasound image device, so that a radiation-absorbed dose in water when X-rays irradiate the water is measured in real time.

Also, according to the present invention, a radiation dose distribution in a wide area is acquired in real time through 3D scanning by an ultrasonic transducer in a form of a linear, arc, or circular array, and a treatment state during clinic radiotherapy is monitored in real time, thereby minimizing radiation exposure during radiotherapy of a patient, and increasing treatment effect.

Also, according to the present invention, an X-ray dose in water, which has a similar environment to an interior of a body, is measured in real time and the distribution thereof is acquired, so that probability of real-time dose measurement in a body is provided. The present invention is utilized as a technology for developing a new-concept radiation dose measurement device that is capable of real-time monitoring a treatment state in radiotherapy using protons, neutrons, or the like, as well as in X-ray treatment.

### DESCRIPTION OF DRAWINGS

FIG. 1 is a functional block diagram illustrating components of a water dosimetry device using X-ray induced ultrasonic waves according to an embodiment of the present invention.

FIG. 2 is a structural diagram illustrating an example of implementation of a water dosimetry device using X-ray induced ultrasonic waves according to an embodiment of the present invention.

FIG. 3A is a diagram illustrating a result of measuring a dose for a sample in water by using a water dosimetry device using X-ray induced ultrasonic waves according to an embodiment of the present invention. FIG. 3B is a diagram illustrating a result of measurement by an ion chamber.

FIG. 4 is a functional block diagram illustrating components of an example of applying, to an animal, a water dosimetry device using X-ray induced ultrasonic waves according to an embodiment of the present invention.

FIG. 5 is a structural diagram illustrating an example of implementation of applying, to an animal, a water dosimetry device using X-ray induced ultrasonic waves according to an embodiment of the present invention.

FIG. 6 is a functional block diagram illustrating components of an example of applying, to radiotherapy, a water dosimetry device using X-ray induced ultrasonic waves according to an embodiment of the present invention.

FIG. 7 is a structural diagram illustrating an example of applying, to radiotherapy, a water dosimetry device using X-ray induced ultrasonic waves according to an embodiment of the present invention.

### Description of the Reference Numerals in the Drawings

100: water dosimetry device according to an embodiment of the present invention

110: water phantom unit

111: 3-axis motor stage

120: medical X-ray linear accelerator

130: ultrasonic transducer

140: amplifying unit

150: data acquisition unit (DAQ)

160: data processing unit (PC)

170: water device composition unit

171: water tube

172: rotary stage

180: gel pad

### BEST MODE

Hereinbelow, exemplary embodiments of the present invention will be described in detail with reference to the accompanying drawings such that the present invention can be easily embodied by those skilled in the art to which this present invention belongs. In describing the exemplary embodiments of the present invention in detail, it is to be noted that, when a detailed description of the known function or components related with the present invention may make the gist of the present invention unclear, a detailed description of those elements will be omitted. Further, throughout the drawings, the same reference numerals refer to parts having similar functions and operations.

Further, throughout the specification, when a part is referred to as being “connected” to another part, it includes not only being “directly connected”, but also being “electrically connected” by interposing the other part therebetween. Further, when a part “includes” an element, it is noted that it further includes other elements, but does not exclude other elements, unless specifically stated otherwise.

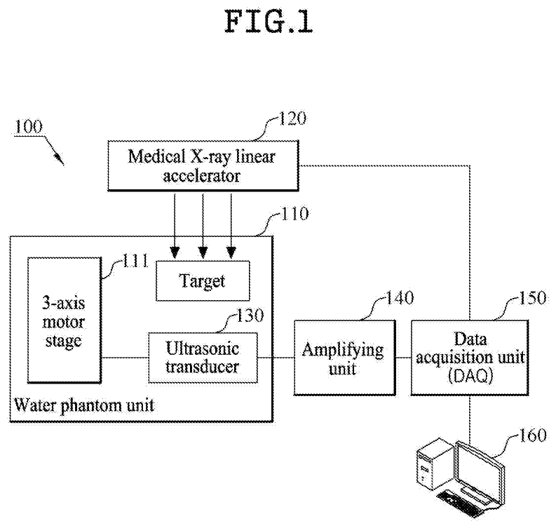

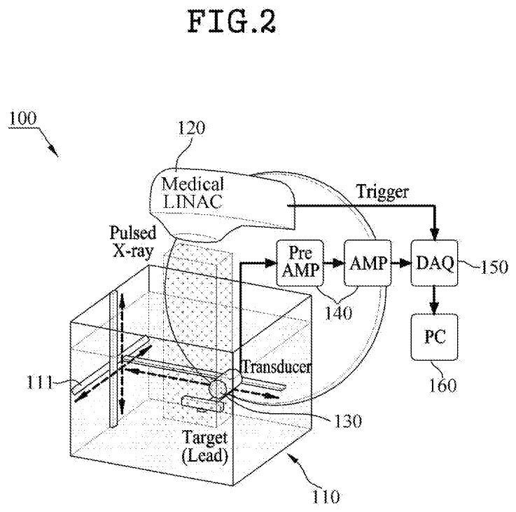

FIG. 1 is a functional block diagram illustrating components of a water dosimetry device using X-ray induced ultrasonic waves according to an embodiment of the present invention. FIG. 2 is a structural diagram illustrating an example of implementation of a water dosimetry device using X-ray induced ultrasonic waves according to an embodiment of the present invention. As shown in FIGS. 1 and 2, a water dosimetry device 100 using X-ray induced ultrasonic waves according to an embodiment of the present invention includes: a water phantom unit 110, a medical X-ray linear accelerator 120, an ultrasonic transducer 130, an amplifying unit 140, a data acquisition unit 150, and a data processing unit 160.

The water phantom unit 110 is a component filled with water, in which a target of a probe sample is placed therein. The water phantom unit 110 may be, as shown in FIG. 2, implemented in a form of a water tank filled with water and with the top opened. Here, the water phantom unit 110 may further include a 3-axis motor stage 111 moving the ultrasonic transducer 130, which will be described later, on three axes. That is, the 3-axis motor stage 111 may move a scanning stage on one, two, and three axes. Further, the water phantom unit 110 may include a linear or rotary scanning stage.

The medical X-ray linear accelerator 120 is a component as a linear accelerator for medical treatment that generates pulse X-rays and irradiates the target in the water phantom unit 110 with pulse X-rays. This medical X-ray linear accelerator 120 corresponds to a common component, so that an unnecessary description of the detailed configuration and operation principle will be omitted.

The ultrasonic transducer 130 is a component detecting an X-ray induced ultrasonic signal that is generated when thermal expansion occurs momentarily as the pulse X-rays radiated from the medical X-ray linear accelerator 120 irradiate the water and then are absorbed. Here, the X-ray induced ultrasonic signal is a sound pressure generated when thermal expansion occurs momentarily as the pulse X-rays irradiate the water and then are absorbed, wherein the sound pressure radiates from the source in all directions and contains information on an X-ray absorbed dose. Here, the doses of X-rays vary depending on the depth of the irradiated water, and the size of the X-ray induced ultrasonic signal is proportional to the size of the absorbed radiation dose.

Further, the ultrasonic transducer 130 is coupled with the 3-axis motor stage 111, performs 3D scanning using three-axis movement on X-Y-Z axes, and detects and acquires an X-ray induced ultrasonic signal as a result of the 3D scanning. The ultrasonic transducer 130 may be implemented as a focus-type single-element ultrasonic transducer. Further, the ultrasonic transducer 130 may be implemented, as an example in a form of detailed composition, as one among a linear array transducer, an arc array transducer, and a circular array transducer.

The amplifying unit 140 is a component as an amplifier amplifying the X-ray induced ultrasonic signal detected by the ultrasonic transducer 130 and outputting the resulting signal. The amplifying unit 140 amplifies the detected weak signal, namely, the X-ray induced ultrasonic signal.

The data acquisition unit 150 is a component of converting the amplified X-ray induced ultrasonic signal output from the amplifying unit 140 into a digital signal and outputting the digital signal. The data acquisition unit (DAQ) 150 performs processing into data that is recognized by the data processing unit 160, which will be described later.

The data processing unit 160 is a component in a form of a personal computer (PC) that analyzes the digitized data output from the data acquisition unit 150 and measures a radiation-absorbed dose. The data processing unit (PC) 160 measures the radiation-absorbed doses in real time using the X-ray induced ultrasonic signal detected by the ultrasonic transducer 130 in real time, wherein on the basis of 3D scanning by the ultrasonic transducer 130, a cross-section radiation-absorbed dose per angle with respect to the position of the target of the probe sample may be measured. Further, the data processing unit collects a measurement value of the cross-section radiation-absorbed dose per angle to acquire a radiation dose distribution in a form of a 3D image, and outputs the distribution for display so as to perform monitoring.

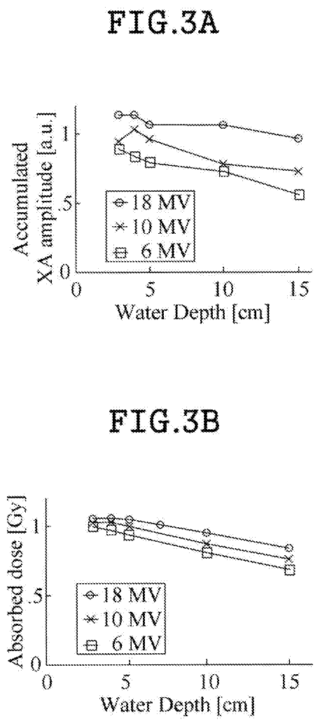

FIG. 3A is a diagram illustrating a result of measuring a dose for a sample in water by using a water dosimetry device using X-ray induced ultrasonic waves according to an embodiment of the present invention. FIG. 3B is a diagram illustrating a result of measurement by an ion chamber. That is, FIG. 3A and FIG. 3B show a comparison between a tendency of a radiation accumulation dose measured by the water dosimetry device 100 according to the present invention and a tendency of a dose measured by an ion chamber. A radiation accumulation dose signal is a result of adding a radiation induced ultrasonic signal for a predetermined time (the time required for the dose to be 1 Gy when X-rays irradiate the water). It is found that the tendencies of the respective graphs comparatively match.

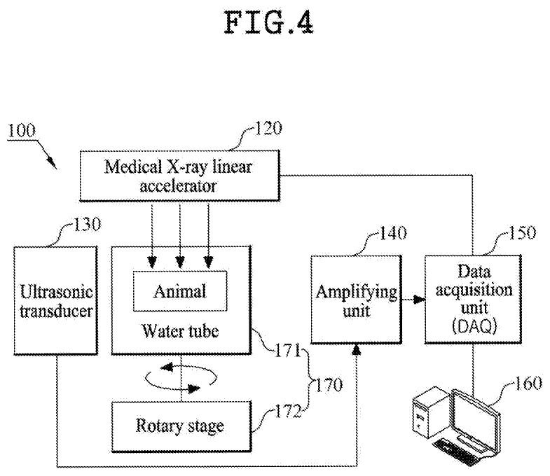

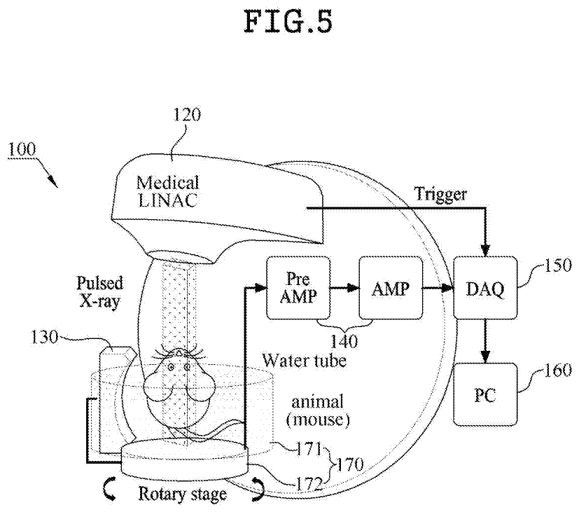

FIG. 4 is a functional block diagram illustrating components of an example of applying, to an animal, a water dosimetry device using X-ray induced ultrasonic waves according to an embodiment of the present invention. FIG. 5 is a structural diagram illustrating an example of implementation of applying, to an animal, a water dosimetry device using X-ray induced ultrasonic waves according to an embodiment of the present invention. As shown in FIGS. 4 and 5, a water dosimetry device 100 using X-ray induced ultrasonic waves according to an embodiment of the present invention includes: a water device composition unit 170, a medical X-ray linear accelerator 120, an ultrasonic transducer 130, an amplifying unit 140, a data acquisition unit 150, and a data processing unit 160.

The water device composition unit 170 is a composition for a water device, wherein a water tube 171 filled with water is provided with an animal placed therein, and a rotary stage 172 rotating the water tube 171 is provided under the water tube 171. The water device composition unit 170 is a composition implemented as an example of a composition for measuring distribution of dose in the body of the animal when the animal is irradiated with radiation.

The medical X-ray linear accelerator 120 is a component as a linear accelerator for medical treatment that generates pulse X-rays and irradiates the animal placed in the water tube 171. The medical X-ray linear accelerator 120 corresponds to a common component, so that an unnecessary description of the detailed configuration and operation principle will be omitted.

The ultrasonic transducer 130 is a component detecting an X-ray induced ultrasonic signal that is generated when thermal expansion occurs momentarily as the pulse X-rays radiated from the medical X-ray linear accelerator 120 irradiate the water and then are absorbed. Here, the X-ray induced ultrasonic signal is a sound pressure generated when thermal expansion occurs momentarily as the pulse X-rays irradiate the water and then are absorbed, wherein the sound pressure radiates from the source in all directions and contains information on an X-ray absorbed dose. Further, the doses of X-rays vary depending on the depth of the irradiated water, and the size of the X-ray induced ultrasonic signal is proportional to the size of the absorbed radiation dose.

Further, the ultrasonic transducer 130 may be, as shown in FIG. 5, placed inside the water tube 171 that the rotary stage 172 rotates. That is, the ultrasonic transducer 130 is implemented as an arc array transducer, performs circular scanning on the water tube 171 that the rotary stage 172 rotates, and detects and acquires an X-ray induced ultrasonic signal as a result of the circular scanning. Further, the ultrasonic transducer 130 may also be implemented as a linear, a circular, or other types of transducers.

The amplifying unit 140 is a component as an amplifier amplifying the X-ray induced ultrasonic signal detected by the ultrasonic transducer 130 and outputting the resulting signal. The amplifying unit 140 amplifies the detected weak signal, namely, the X-ray induced ultrasonic signal, to process.

The data acquisition unit 150 is a component of converting the amplified X-ray induced ultrasonic signal output from the amplifying unit 140 into a digital signal and outputting the digital signal. The data acquisition unit 150 performs conversion into a form of data that is recognized by the data processing unit 160 which will be described later.

The data processing unit 160 is a component that analyzes the digitized data output from the data acquisition unit 150 and measures a radiation-absorbed dose. The data processing unit 160 may be implemented in a form of a personal computer (PC) which measures the radiation-absorbed dose in real time using the X-ray induced ultrasonic signal detected by the ultrasonic transducer 130 in real time. On the basis of circular scanning by the ultrasonic transducer 130, a cross-section radiation-absorbed dose per circular angle with respect to the position of the animal is measured. A measurement value of the cross-section radiation-absorbed dose per circular angle is collected to acquire a radiation dose distribution in a form of a 3D image, and the distribution is output for display so as to perform monitoring.

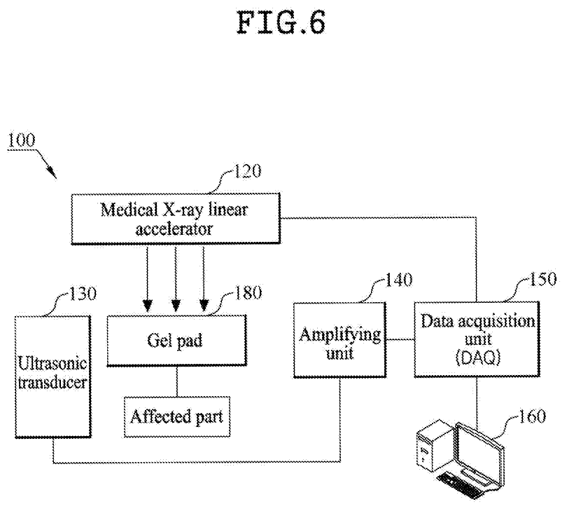

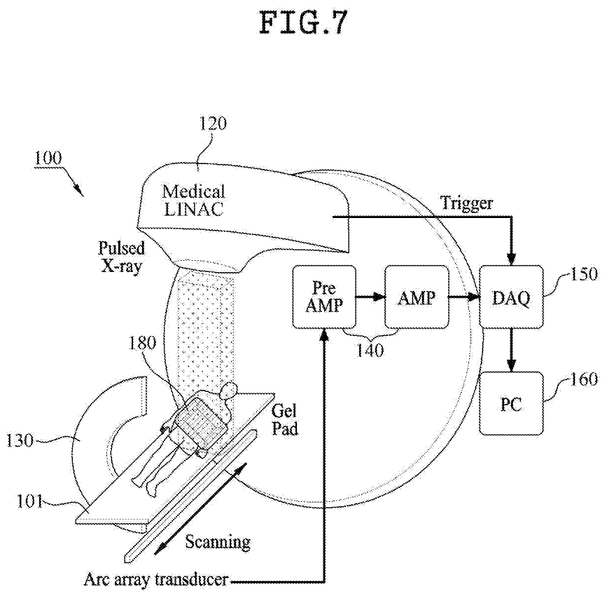

FIG. 6 is a functional block diagram illustrating components of an example of applying, to radiotherapy, a water dosimetry device using X-ray induced ultrasonic waves according to an embodiment of the present invention. FIG. 7 is a structural diagram illustrating an example of applying, to radiotherapy, a water dosimetry device using X-ray induced ultrasonic waves according to an embodiment of the present invention. As shown in FIGS. 6 and 7, a water dosimetry device 100 using X-ray induced ultrasonic waves according to an embodiment of the present invention includes: a gel pad 180, a medical X-ray linear accelerator 120, an ultrasonic transducer 130, an amplifying unit 140, a data acquisition unit 150, and a data processing unit 160.

The gel pad 180 is a component as a pad filled with water, which is placed on an affected part of a treatment target patient lying on a bed 101. The gel pad 180 is an example of a component placed widely on the affected part of the treatment target patient and for measuring the dose in the body when radiotherapy is performed. That is, X-rays radiate through the water of the gel pad 180, so that the level of radiation exposure to normal cells is reduced.

The medical X-ray linear accelerator 120 is a component as a linear accelerator for medical treatment that generates pulse X-rays and irradiates an affected part of a treatment target patient on which the gel pad 180 filled with water is placed. This medical X-ray linear accelerator 120 corresponds to a common component, so that an unnecessary description of the detailed configuration and operation principle will be omitted.

The ultrasonic transducer 130 is a component detecting an X-ray induced ultrasonic signal generated as the pulse X-rays radiated from the medical X-ray linear accelerator 120 pass through the gel pad 180, which serves as a medium, and the affected part absorbs the X-rays. The ultrasonic transducer 130 may be implemented, as shown in FIG. 7, as an arc array transducer moving in the longitudinal direction of the bed 101 to scan the treatment target patient lying on the bed 101. Further, in addition to the arc array transducer, the ultrasonic transducer 130 may be used by being replaced with a circular or linear array transducer. Further, the use of the ultrasonic transducer 130, such as an arc, circular, or linear array transducer, enables acquisition of various types of images. Here, the gel pad 180 serves as a medium to transmit, to the transducer, an induced ultrasonic signal generated as a result that when the affected part is irradiated with medical X-rays, the affected part absorbs the X-rays.

The amplifying unit 140 is a component as an amplifier amplifying the X-ray induced ultrasonic signal detected by the ultrasonic transducer 130 and outputting the resulting signal. The amplifying unit 140 amplifies the detected weak signal, namely, the X-ray induced ultrasonic waves, into a signal on which signal processing is possible.

The data acquisition unit 150 is a component converting the amplified X-ray induced ultrasonic signal output from the amplifying unit 140 into a digital signal and outputting the digital signal. The data acquisition unit (DAQ) 150 performs processing into data that is recognized by the data processing unit 160 which will be described later.

The data processing unit 160 is a component analyzing the digitized data output from the data acquisition unit 150 and measuring a radiation-absorbed dose. The data processing unit 160 may be implemented in a form of a personal computer (PC) which measures the radiation-absorbed dose in real time using the X-ray induced ultrasonic signal detected by the ultrasonic transducer 130 in real time. On the basis of scanning by the ultrasonic transducer 130 in the longitudinal direction of the bed 101, the radiation-absorbed dose on the affected part is measured and monitored using, as a medium, the gel pad 180 placed on the affected part of the treatment target patient lying on the bed 101, whereby radiotherapy is performed and simultaneously, the damage caused by wrong radiation exposure is minimized on the basis of the monitoring. That is, since the X-rays pass through the water of the gel pad 180 and the affected part of the treatment target patient is irradiated with the X-rays, the level of radiation exposure to normal cells is reduced. Further, at the same time as the treatment, monitoring of a dose is performed to adjust the irradiation level of the X-rays, whereby the damage caused by wrong radiation exposure is minimized.

As described above, the water dosimetry device using X-ray induced ultrasonic waves according to an embodiment of the present invention provides the probability of real-time dose measurement when radiation irradiates an interior of a human body, in a situation where there is no a medical linear accelerator-based ultrasound imaging device commercialized currently and a real-time dose estimation for safe treatment is required. Therefore, effectiveness and stability of radiotherapy are increased. Further, the water dosimetry device using X-ray induced ultrasonic waves is implemented using the existing medical radiation accelerator and the existing ultrasound system used in hospitals, so that it is very advantageous to enter the market. Development of medical measurement device based on X-rays and ultrasonic waves may greatly contribute to development of convergence research in research fields that requires understanding between various studies, such as physics, chemistry, electronics, biology, medicine, and the like and to development of a medical imaging device field. The impact on surrounding studies and industries is expected to be substantial. Particularly, the water dosimetry device using X-ray induced ultrasonic waves of the present invention does not have difficult use condition, compared to other existing dosimeters, such as radiophotoluminescence dosimeters, glass dosimeters, chemical dosimeters, or the like. Further, real-time dose measurement in water is possible.

The present invention may be embodied in many different forms by those skilled in the art, without departing from the scope of the present invention. Also, the technical scope of the present invention is defined only by the accompanying claims.

1. A water dosimetry device (100) using X-ray induced ultrasonic waves, the water dosimetry device comprising:
a water phantom unit (110) filled with water, in which a target of a probe sample is placed therein;
a medical X-ray linear accelerator (120) generating pulse X-rays and irradiating the target in the water phantom unit (110);
an ultrasonic transducer (130) detecting an X-ray induced ultrasonic signal generated when thermal expansion occurs momentarily as the pulse X-rays radiated from the medical X-ray linear accelerator (120) irradiate the water and then are absorbed;
an amplifying unit (140) amplifying the X-ray induced ultrasonic signal detected by the ultrasonic transducer (130) and outputting the amplified X-ray induced ultrasonic signal;
a data acquisition unit (DAQ) 150 converting the amplified X-ray induced ultrasonic signal output from the amplifying unit (140) into a digital signal and outputting the digital signal; and
a data processing unit (PC) (160) analyzing digitized data output from the data acquisition unit (150) and measuring a radiation-absorbed dose.

2. The water dosimetry device of claim 1, wherein the X-ray induced ultrasonic signal is a sound pressure generated when thermal expansion occurs momentarily as the pulse X-rays irradiate the water and then are absorbed, and the sound pressure radiates from a source in all directions and contains information on an X-ray absorbed dose.

3. The water dosimetry device of claim 2, wherein doses of the X-rays vary depending on a depth of the irradiated water, and a size of the X-ray induced ultrasonic signal is proportional to a size of an absorbed radiation dose.

4. The water dosimetry device of claim 1, wherein the water phantom unit (110) is provided in a form of a water tank filled with the water and with a top opened.

5. The water dosimetry device of claim 1, wherein the water phantom unit (110) further includes a 3-axis motor stage (111) moving the ultrasonic transducer (130) on three axes.

6. The water dosimetry device of claim 5, wherein the ultrasonic transducer (130) is coupled with the 3-axis motor stage (111), performs 3D scanning using three-axis movement on X-Y-Z axes, and detects and acquires the X-ray induced ultrasonic signal as a result of the 3D scanning.

7. The water dosimetry device of claim 6, wherein the ultrasonic transducer (130) is implemented as a focus-type single-element ultrasonic transducer.

8. The water dosimetry device of claim 6, wherein the ultrasonic transducer (130) is implemented as one among a linear array transducer, an arc array transducer, and a circular array transducer.

9. The water dosimetry device of claim 1, wherein the data processing unit (160) measures the radiation-absorbed dose in real time using the X-ray induced ultrasonic signal detected by the ultrasonic transducer (130) in real time, and on the basis of 3D scanning by the ultrasonic transducer (130), a cross-section radiation-absorbed dose per angle with respect to a position of the target of the probe sample is measured.

10. The water dosimetry device of claim 9, wherein the data processing unit collects a measurement value of the cross-section radiation-absorbed dose per angle to acquire a radiation dose distribution in a form of a 3D image, and outputs the distribution for display so as to perform monitoring.

11. A water dosimetry device (100) using X-ray induced ultrasonic waves, the water dosimetry device comprising:
a water device composition unit (170) in which a water tube (171) filled with water is provided with an animal placed therein, and a rotary stage (172) rotating the water tube (171) is provided under the water tube (171);
a medical X-ray linear accelerator (120) generating pulse X-rays and irradiating the animal placed in the water tube (171);
an ultrasonic transducer (130) detecting an X-ray induced ultrasonic signal generated when thermal expansion occurs momentarily as the pulse X-rays radiated from the medical X-ray linear accelerator (120) irradiate the water and then are absorbed;
an amplifying unit (140) amplifying the X-ray induced ultrasonic signal detected by the ultrasonic transducer (130) and outputting the amplified X-ray induced ultrasonic signal;
a data acquisition unit (DAQ) 150 converting the amplified X-ray induced ultrasonic signal output from the amplifying unit (140) into a digital signal and outputting the digital signal; and
a data processing unit (PC) (160) analyzing digitized data output from the data acquisition unit (150) and measuring a radiation-absorbed dose.

12. The water dosimetry device of claim 11, wherein the X-ray induced ultrasonic signal is a sound pressure generated when thermal expansion occurs momentarily as the pulse X-rays irradiate the water and then are absorbed, and the sound pressure radiates from a source in all directions and contains information on an X-ray absorbed dose.

13. The water dosimetry device of claim 12, wherein doses of the X-rays vary depending on a depth of the irradiated water, and a size of the X-ray induced ultrasonic signal is proportional to a size of an absorbed radiation dose.

14. The water dosimetry device of claim 11, wherein the ultrasonic transducer (130) is placed inside the water tube (171) that the rotary stage (172) rotates.

15. The water dosimetry device of claim 14, wherein the ultrasonic transducer (130) is implemented as an arc array transducer, performs circular scanning on the water tube (171) that the rotary stage (172) rotates, and detects and acquires the X-ray induced ultrasonic signal as a result of the circular scanning.

16. The water dosimetry device of claim 15, wherein the data processing unit (160) is configured to, measure the radiation-absorbed dose in real time using the X-ray induced ultrasonic signal detected by the ultrasonic transducer (130) in real time; measure, on the basis of the circular scanning by the ultrasonic transducer (130), a cross-section radiation-absorbed dose per circular angle with respect to a position of the animal; and collect a measurement value of the cross-section radiation-absorbed dose per circular angle to acquire a radiation dose distribution in a form of a 3D image and output the distribution for display so as to perform monitoring.

17. A water dosimetry device (100) using X-ray induced ultrasonic waves, the water dosimetry device comprising:
a gel pad (180) filled with water and placed on an affected part of a treatment target patient lying on a bed (101);
a medical X-ray linear accelerator (120) generating pulse X-rays and irradiating the affected part of the treatment target patient on which the gel pad (180) filled with the water is placed;
an ultrasonic transducer (130) detecting an X-ray induced ultrasonic signal generated as the pulse X-rays radiated from the medical X-ray linear accelerator (120) pass through the gel pad (180), which serves as a medium, and the affected part absorbs the X-rays;
an amplifying unit (140) amplifying the X-ray induced ultrasonic signal detected by the ultrasonic transducer (130) and outputting the amplified X-ray induced ultrasonic signal;
a data acquisition unit (DAQ) 150 converting the amplified X-ray induced ultrasonic signal output from the amplifying unit (140) into a digital signal and outputting the digital signal; and
a data processing unit (PC) (160) analyzing digitized data output from the data acquisition unit (150) and measuring a radiation-absorbed dose.

18. The water dosimetry device of claim 17, wherein the ultrasonic transducer (130) is implemented as an arc array transducer moving in a longitudinal direction of the bed (101) to scan the treatment target patient lying on the bed (101).

19. The water dosimetry device of claim 18, wherein the ultrasonic transducer (130) is used by being replaced with a circular or linear array transducer in addition to the arc array transducer.

20. The water dosimetry device of claim 18, wherein the data processing unit (160) is configured to, measure the radiation-absorbed dose in real time using the X-ray induced ultrasonic signal detected by the ultrasonic transducer (130) in real time; and measure and monitor, on the basis of the scanning by the ultrasonic transducer (130) in the longitudinal direction of the bed (101), the radiation-absorbed dose on the affected part by using, as a medium, the gel pad (180) placed on the affected part of the treatment target patient lying on the bed (101), whereby radiotherapy is performed and simultaneously, a damage caused by wrong radiation exposure is minimized on the basis of the monitoring.
